(19) United States
(12) Patent Application Publication
(10) Pub. No.: US 2007/0228113 A1
(43) Pub. Date: Oct. 4, 2007

(54) Method of manufacturing metallic foam based heat exchanger

(76) Inventors: Ronald L. Dupree, Washington, IL (US); James J. Callas, Peoria, IL (US); Jeremy S. Trethewey, Dunlap, IL (US)

Correspondence Address: CATERPILLAR c/o LIELL & MCNEIL ATTORNEYS PC, P.O. BOX 2417, 511 SOUTH MADISON STREET, BLOOMINGTON, IN, 47402-2417, US

(21) Appl. No.: 11/390,636

(22) Filed: Mar. 28, 2006

(51) Int. Cl. B23K 31/02

(52) U.S. Cl. 228/183

(57) ABSTRACT

A method of manufacturing a metallic foam based heat exchanger includes positioning an aluminum foam block, for example, within a housing defining a first fluid passage, and placing the block in contact with a second portion of the housing defining at least one other fluid passage, the second housing portion being an extrusion. A brazing flux material and a brazing filler are applied to at least one of the foam and the extrusion, the foam being thermally coupled to the extrusion with the brazing filler via heating in a brazing furnace. A heat exchanger includes a housing having a fluid passage with a metallic foam such as an aluminum foam therein. The metallic foam is attached to a metallic extrusion such as an aluminum extrusion, and connected therewith via a thermally conducting brazing filler. A method of cooling oil in an internal combustion engine is further provided, including the step of passing high temperature oil through an aluminum foam in a fluid passage of a first housing portion, and passing low temperature fluid through a second passage in a second housing portion. Heat is exchanged between the high temperature oil and the low temperature fluid at least in part via a thermally conducting attachment material joining the aluminum foam with the second portion of the housing.

### TECHNICAL FIELD

The present disclosure relates generally to heat exchangers and manufacturing methods therefor, and relates more particularly to a method of manufacturing a metallic foam based heat exchanger for use as an oil cooler in an internal combustion engine system.

### BACKGROUND

Heat exchangers are used in a variety of applications in modern engine systems. Internal combustion engine radiators, turbocharger intercoolers and exhaust aftercoolers are examples of heat exchangers. In addition, heat exchangers may be used to control the temperature of engine oil, transmission fluid and even air supplied to the engine or used in temperature control of an operator cabin in a work machine.

Many work machines, including off-highway work machines and on-highway trucks, for example, utilize a variety of different heat exchangers coupled with their respective engine systems. Certain heat exchangers such as oil coolers are commonly coupled with the engine coolant fluid circulation system, which ultimately circulates coolant fluid through the main engine radiator. Heat from the engine oil can thereby be dissipated to the external environment. In other systems the heat exchanger may be a stand alone device independent of the main engine radiator and utilizing another coolant fluid such as air. While many of these heat exchangers serve vital functions for the engine system, the heat exchanger units and their accompanying plumbing systems can add significant weight and complexity to the work machine. As in many technical areas there is often motivation to reduce the size, weight and complexity of components; engineers are thus continually seeking to address such concerns, but without sacrificing performance.

One means by which designers have sought to reduce size and complexity of heat exchangers is through the development of more efficient heat exchanger systems having relatively large heat exchange surfaces per unit volume and/or mass. Higher efficiency heat exchangers may occupy relatively smaller spaces within an engine compartment and weigh less than conventional designs. Recent and forthcoming jurisdictional changes in engine emissions and operating requirements have also prompted engineers to search for improved ways of managing heat in internal combustion engine systems, without adding weight, size or complexity. In particular, because certain reduced emissions operating strategies require more heat to be rejected from the engine than was traditionally required, designers have been still further motivated to improve efficiency.

One known type of heat exchanger commonly used in engine systems is known in the art as a bar and plate style heat exchanger. A typical bar and plate heat exchanger, such as might be used as an air cooled heat exchanger in an engine, includes a core consisting of a first set of fluid passages for a first fluid, positioned in an alternating arrangement with another set of passages for a second fluid. In one known design, air passed through a set of air passages exchanges heat with engine coolant fluid circulated through the other set of fluid passages. Metallic fins are disposed within the respective passages to provide heat transfer surface area. A plurality of bars and plates are connected together to provide walls for isolating the respective fluid channels and an overall structure for the heat exchanger core. In some variants of the basic bar and plate design, a convoluted woven metal cloth is used in place of the fins.

While bar and plate style heat exchangers have enjoyed a long and successful history in the internal combustion engine arts, there are limitations to known designs, now increasingly apparent in light of the new challenges facing heat exchanger designers. For example, because one factor affecting heat exchanger efficacy relates to the available heat exchange surface area, improvements in bar and plate heat exchanger performance tend to require either a larger overall heat exchanger or a greater ratio of surface area to volume. Increasing heat exchanger size is often not a viable option, as it can add weight to the overall system, and because spatial and packaging constraints may limit heat exchanger size. Increasing the heat exchange surface area to volume ratio typically requires tighter packing of heat exchange fins within the respective fluid passages. While increasing fin density works up to a point, additional fins can reduce the attainable flow rate or pressure for fluids through the heat exchanger to a point that an unacceptable fluid pressure drop across the heat exchanger occurs.

Certain specific heat exchanger applications have demonstrated their own set of challenges. One type of heat exchanger, in particular used in engine mounted oil to water heat exchangers, is known in the art as a shell and tube heat exchanger. In a conventional shell and tube design, water or engine coolant is passed through a housing via one or more tubes. The housing, which comprises the “shell” is positioned about the tubes, and provides another passage through which oil, such as engine oil, may be passed such that heat may be exchanged between the two fluids. While such designs have heretofore presented a practical strategy for oil cooling, there remains room for improvement both in terms of size, manufacturing complexity and operating efficiency. The search for improvements to traditional designs such as bar and plate and shell and tube configurations has most recently focused on the use of certain unconventional and exotic heat exchange materials.

One example of the use of nontraditional materials for a heat exchanger, in particular a heat exchanger for a type of heat pump known as a thermo-acoustic conversion device, is known from United States Patent Application Publication No. 2004/0226702 to Toonen et al. (Toonen). Toonen is directed to a heat exchanger for transferring heat from a first fluid to another fluid. In particular, the disclosure discusses transferring heat from water to air, the air being passed through a flow body including a copper foam which is positioned about a plurality of small copper water-carrying tubes. The copper foam has a gradient to provide a desired balance of heat transfer between the fluids as compared to flow resistance. While Toonen discloses a design purportedly suited to certain applications, in particular a relatively small-dimensioned heat exchanger application such as a thermo-acoustic conversion device, the design has a number of limitations.

For instance, in several of the Toonen designs, machining of the foam is required to give it a desired shape, including recesses in the foam for accommodating the copper water carrying tubes. Machining relatively complex features inevitably increases production time and effort. Further, the illustrated configuration wherein the tubes are spaced apart from one another within the foam requires numerous individual parts to be separately positioned during assembly. In addition, the spaced apart water carrying tubes would impart little, if any, additional structural integrity to the heat exchanger apparatus. While a heat exchanger's structural rigidity and overall strength might be of relatively little importance in a thermo-acoustic heat pump, the Toonen configuration may be less applicable where stiffness and strength of the heat exchanger are important. Toonen further discloses a heat exchange structure having rectangular flow passages alternating with rectangular foam flow bodies. Although Toonen is silent as to how the rectangular flow passages are manufactured, the configuration could theoretically be somewhat more rigid than the design having spaced apart tubes within the foam. However, Toonen offers little detail as to how the rectangular structure is fluidly sealed, supported, housed, etc. Thus, the individual flow passages and foam would appear to be joined together separately from connecting the overall structure with any sort of housing, adding undesirable complexity to the manufacturing process.

The present disclosure is directed to one or more of the problems or shortcomings set forth above.

### SUMMARY OF THE DISCLOSURE

In one aspect, the present disclosure provides a heat exchanger, including a housing having a first fluid passage and an extrusion having at least one other fluid passage therein. The heat exchanger further includes a metallic foam configured to exchange heat between fluids in the first and at least one other fluid passage of the housing. The metallic foam is disposed within the first fluid passage and connected with the extrusion via a thermally conducting attachment material.

In another aspect, the present disclosure provides a method of manufacturing a metallic foam based heat exchanger. The method includes the step of positioning a plurality of housing panels about a metallic foam, the housing panels comprising a first housing portion. The method further includes the step of thermally coupling the foam with a second housing portion that includes an extrusion having therein at least one fluid passage, at least in part via a heat conducting attachment material. The method still further includes the step of joining the first housing portion with the second housing portion at least in part via a step of heating the first and second housing portions together in a brazing furnace.

In still another aspect, the present disclosure provides a method of cooling oil in an internal combustion engine system, including the step of passing high temperature oil through an aluminum foam disposed within a first fluid passage in a first housing portion of a heat exchanger. The method further includes the steps of passing low temperature fluid through at least one other fluid passage in a second housing portion of the heat exchanger, and exchanging heat between the high temperature oil and the low temperature fluid at least in part via a thermally conducting material joining the aluminum foam with the second housing portion.

### BRIEF DESCRIPTION OF THE DRAWINGS

FIG. 1 is a diagrammatic view of an engine system according to the present disclosure;

FIG. 2 is a perspective view of an aluminum foam based heat exchanger according to the present disclosure; and

FIG. 3 is an exploded view in perspective of certain of the components of the heat exchanger of FIG. 2.

### DETAILED DESCRIPTION

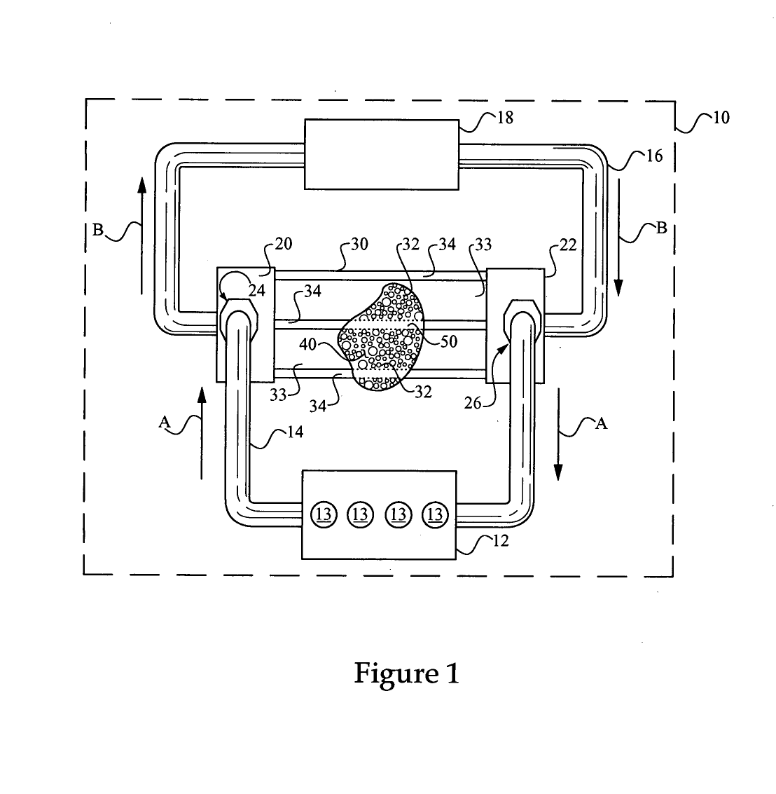

Referring to FIG. 1, there is shown an engine system 10 according to one embodiment of the present disclosure. Engine system 10 includes an engine 12 such as an internal combustion engine having a plurality of cylinders 13. Engine 12 may comprise a compression ignition engine or a spark ignited engine, for example, or another engine type. It is contemplated that engine system 10 may be mounted in a mobile work machine, such as an off-highway work machine, or it might be a stand alone engine system such as the type used in electrical power generation, or still another type of engine system. An oil conduit 14 connects with engine 12 and is configured to circulate engine cooling oil in a conventional manner. Engine system 10 further includes a radiator 18 coupled with an engine coolant conduit 16. Arrows A illustrate a direction of engine oil flow, whereas Arrows B indicate a flow of engine coolant in a direction opposite to oil flow. In other embodiments, coolant and oil might flow in the same direction, a perpendicular direction, etc.

A heat exchanger 30 is coupled with each of conduits 14 and 16, and configured to exchange heat between the fluids flowing therein. Heat exchanger 30 may be coupled with a first manifold 20 and a second manifold 22. First manifold 20 may include an oil inlet 24, whereas second manifold assembly 22 may include an oil outlet 26. Manifold assemblies 20 and 22 may be configured to distribute oil and coolant among a plurality of separate, fluidly isolated passages in heat exchanger 30, to allow the exchange of heat between the two fluids. In the embodiment of FIG. 1, heat exchanger 30 may thus act as an oil cooler, allowing heat from engine oil or another oil to be transferred to engine coolant, and thenceforth to air via radiator 18. Other applications for heat exchanger 30 than cooling engine oil are contemplated, as described herein.

Heat exchanger 30 may further include a plurality of first housing portions 33 and a plurality of second housing portions 34 positioned in an alternating stacked configuration. Each set of a first and second housing portion comprises a heat exchanger subassembly, a plurality of heat exchanger subassemblies thus being stackable to provide a heat exchanger having a desired size, weight and heat exchange capability. Those skilled in the art will recognize that the number of subassemblies connected together may determine the total number of fluid passages and thus dictate the particular configuration of the respective manifolds used to apportion fluid within the heat exchanger. Each of the housing portions will include at least one fluid passage therein. First housing portions 33 may therefore include a first fluid passage 40, which in the case of an oil cooler embodiment may be an oil passage. At least one engine coolant fluid passage 50 may be disposed within each of second housing portions 34, such that heat may be exchanged between oil flowing through each oil passage 40 and coolant fluid flowing through each coolant fluid passage 50.

As described herein, the number of alternating stacked housing portions and, hence, heat exchanger subassemblies may be varied depending upon the application. Each subassembly will typically include at least one housing portion having one or more oil passages, and at least one housing portion having one or more coolant fluid passages. It is contemplated that a single oil passage 40 in housing portion(s) 33 will provide one practical implementation strategy, as described herein, however, multiple oil passages per each first housing portion 33 might be used without departing from the scope of the present disclosure.

A metallic foam, for example an open cell aluminum foam block 32, will be disposed in at least one of passages 40 and 50. It is contemplated that a unitary foam block cut to a predetermined size and shape from a larger, parent block will be positioned within each oil passage 40, but not within the coolant passages 50. Aluminum foam might be used in both the engine coolant and oil passages if desired, however, or in only the engine coolant passages in certain applications. In other embodiments, alternative materials such as copper, stainless steel, and other metals or alloys may be used. The number of pores per square inch of the metallic foam may be varied, depending upon the desired characteristics of the heat exchanger, for example the pressure drop between the fluid inlet and outlet. In still further embodiments, the number of pores per square inch may be varied within an individual foam black to establish a gradient. In addition, the “apparent density” of the foam may vary in different heat exchangers, as well as within an individual foam block. Apparent density may be understood as the ratio of volume occupied by metal in the foam to the entire volume occupied by the foam, or a defined portion thereof. These factors may be varied to “tune” a particular foam block to provide particular operational characteristics for purposes which will be apparent to those skilled in the art.

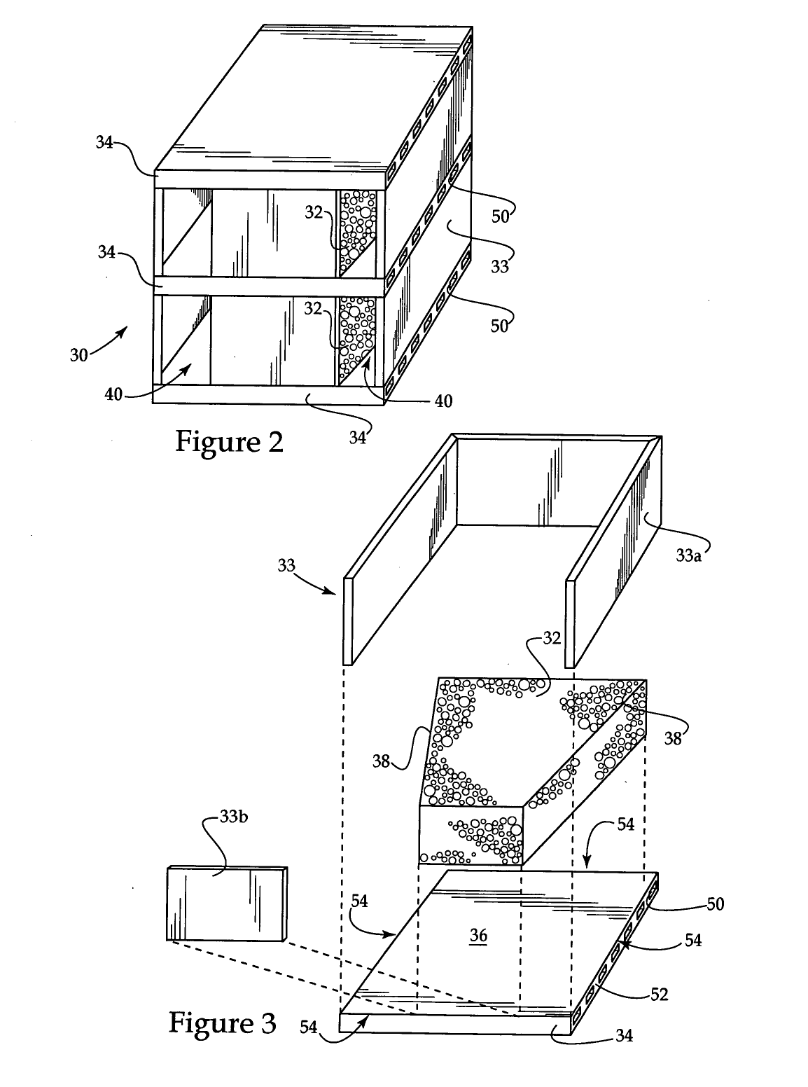

Turning to FIG. 2, there is shown in perspective an assembled oil cooler/heat exchanger 30 similar to the one shown in FIG. 1. Each of the housing portions 33 and 34 may be positioned in the illustrated alternating stacked configuration such that an oil passage 40 in each of first housing portions 33 alternates with a plurality of engine coolant fluid passages 50 extending in each of second housing portions 34. Thus, the FIG. 2 embodiment includes two heat exchanger subassemblies stacked together, each consisting of first and second housing portions. Although the respective passages for oil and engine coolant fluid, and the respective circulation directions may be such that engine coolant flow and oil flow will be approximately in reverse directions within heat exchanger 30, the present disclosure is not limited to such a configuration. For example, one or more oil passages might be oriented such that oil flows in cross flow to engine coolant fluid, or even in the same direction, without departing from the intended spirit and scope of the present disclosure.

Turning to FIG. 3, there is shown an exploded view in perspective of a heat exchanger subassembly such as that included in heat exchanger 30 of FIG. 2. As illustrated, housing portion 33 may include a plurality of housing panels, including at least a first panel 33a and a second panel 33b. Each of the first and second panels may consist of a metallic plate such as an aluminum plate, the specific right-angled configuration of first piece 33a being formed by bending one relatively large piece or by joining/positioning a plurality of smaller panels together in the desired configuration, or by some other process. Each of first and second panels 33a and 33b may be joined to second housing portion 34 by brazing or by another suitable process, as described herein. In the configuration shown in FIG. 3, panels 33a and 33b may be oriented generally perpendicular a planar exterior surface 36 of second housing portion 34 and connected therewith adjacent peripheral edges 54. Second housing portion 34 may include another planar exterior surface opposite surface 36, although such is not shown in FIG. 3 due to the selected view.

Second housing portion 34 may comprise an extrusion. The extrusion may be, for example, a relatively thin, rectangular multi-port metallic extrusion formed from a single piece of metal such as aluminum and having planar front 36 and back surfaces. Alternatively, the extrusion might comprise a plurality of individual extruded tubes arranged adjacently. In the case of a multi-port metallic extrusion, each of the plurality of fluid passages 50 may be separated one from the other by stiffeners 52 formed during extruding of housing portion 34 (hereafter “extrusion 34”). Stiffeners 52 may comprise longitudinal ribs internal to the respective extrusion separating and fluidly isolating the individual passages 50, and oriented perpendicular front 36 and back surfaces of extrusion 34. Thus, each fluid passage may be separated from adjacent fluid passages by one or more longitudinal stiffeners. Where individual extruded tubes coupled side by side are used, the adjacent walls of each of the tubes may serve as “stiffeners” for extrusion 34.

In either case, extrusion 34 will typically comprise a structural substrate for heat exchanger 30, wherein stiffeners 52 stiffen not only extrusion 34 but heat exchanger 30 itself. Stiffeners 52 may also provide heat exchange surface area between adjacent passages, and heat exchange surface area for exchange of heat between the separate fluids. Extrusions having a variety of structural and materials characteristics are readily available from commercial sources known to those of skill in the art, including Brazeway of Adrian, Mich. In alternative designs, a cast or machined second housing portion rather than an extruded housing portion might be used. It is contemplated that the respective pieces/panels of first housing portion 33 may be connected to upper surface 36 of extrusion 34 along peripheral edges 54 thereof, via a brazing process as described herein, or via another suitable process. Each extrusion portion 34 may thus comprise a wall of passage 40, as in the embodiment of FIG. 2, and housing panels 33a and 33b, in combination therewith define first fluid passage 40.

FIG. 3 also illustrates in perspective a metallic foam block 32, for example an aluminum foam block, which may be positioned within oil passage 40. Baffles, for example positioned to extend perpendicular a direction of fluid flow in oil passage 40, may also be included for reasons familiar to those skilled in the heat exchanger arts. In other instances, however, the inclusion of baffles may be limited or unwarranted where an excessive pressure drop would occur. Aluminum foam block 32 will provide a relatively large secondary heat transfer surface area for exchanging heat between oil in passage 40 and engine coolant or another fluid in passages 50. In addition, the use of a foam tends to promote turbulent flow, a characteristic generally desirable in heat exchanger operation. Block 32 may include first and second tapered edges 38 to facilitate oil flow into or out of passage 40. Blocks of aluminum foam are readily commercially available, for example, from LightWeight Solutions, Inc. of Newark, Del. Other metal foams are readily available from a variety of commercial sources. In one practical implementation strategy, block 32 will be compression fit or crushed within heat exchanger 30 to enhance the mechanical and thermal coupling between block 32 and the other components. Crushing or compression fitting aluminum foam block 32 may comprise reducing the volume of the foam block by up to about ten percent, for example, between the adjacent extrusions 34. Crushing of aluminum foam block 32 between extrusions 34 may thus provide more contact surface area between the aluminum foam and the planar surfaces 36 than would be available by merely placing block 32 in contact therewith. Additional and/or alternative means for increasing available attachment surface area include machining, e.g. grinding, the foam ligament faces or surfaces, in effect “smearing” the material, or forming the metallic foam with an external skin, that is closed cell or non-cellular in nature, where joined with the other components of the heat exchanger. In one contemplated embodiment, described herein, the exchange of heat between fluids in the respective passages will take place via a thermally conducting attachment material connecting aluminum foam block 32 with extrusions 34. The manufacturing/assembly process for heat exchanger 30 described herein will allow the selected thermally conducting attachment material to be spread across substantially the entire area of contact between aluminum foam block 32 and extrusions 34. In other words, in certain embodiments, the entire footprint of each aluminum foam block on the respective surface of adjacent extrusions may serve as a zone for thermally coupling the foam block with the extrusion via the thermally conducting attachment material.

The thermally conducting attachment material may be a brazing filler, for example an aluminum based brazing filler, joining the respective housing portions 33, 34 and aluminum foam block 32 together and thermally coupling the same. The present disclosure also contemplates the use of an aluminum foam block having a relatively higher pore density in regions which are connected to other heat exchanger components, and a relatively lower pore density in other regions. Such a design provides a relatively higher surface area for connecting the foam, via greater density of foam ligaments, without overly inhibiting fluid flow in other regions. While the described aluminum foam blocks cut from larger parent blocks are contemplated to provide one practical implementation strategy, the present disclosure is not thereby limited. For example, rather than a unitary foam block, several blocks or even numerous pieces of metallic foam could be positioned in heat exchanger 30. As mentioned above, baffles may be incorporated between or within pieces of the foam, to assist in directing fluid flow and to increase turbulence.

Heat exchanger 30 may be manufactured by a process whereby the various components are joined with one another via a brazing process. One suitable brazing process for a particular suite of materials is known in the art as nocolok brazing, although the present disclosure is not thereby limited. A practical manufacturing strategy, where aluminum is used, may include positioning housing panels 33a and 33b about aluminum foam block 32. Aluminum foam block 32 may then be thermally coupled with extrusion 34 via heat conducting attachment material such as a brazing material or a suitable thermally conductive adhesive. As described herein, housing portions 33 and 34, coupled together, may be thought of as a heat exchanger subassembly. Where a heat exchanger having plural subassemblies is to be manufactured, additional foam blocks, housing panels and extrusions may be added as needed. The entire set of subassemblies may be clamped or otherwise temporarily secured together in the desired configuration. Compression fitting of block 32 may take place when assembling the subassemblies or prior thereto. Prior to or after each of the heat exchanger components are arranged in the desired configuration, a brazing flux material and a brazing filler may be applied to each of the areas of the heat exchanger to be joined. The brazing flux material and brazing filler may be applied to the entire assembly, or to the individual parts in zones where they are to be attached by any suitable process such as dipping, spraying, flooding, etc. A variety of suitable brazing pastes are also available commercially, and may be appropriate where increased viscosity of the paste as compared to a liquid material is desirable. A relatively thick, spreadable paste may be used for increased depth or thickness of the filler material between the portions of the heat exchanger to be joined, for example.

One suitable brazing flux material includes a potassium fluoroaluminate salt (KF:AlF₃) which may be applied by dipping, spraying, flooding, etc. as an aqueous slurry at 5% to 25% concentration, for example. Those skilled in the art will appreciate that the suitability of a selected brazing flux material will depend at least in part upon the composition and properties of aluminum foam block 32 and extrusion 34. For relatively lower temperature applications, approximately 580° C. for example, Cesium based flux materials and others may be used. In general, extruded aluminum has heretofore been available in a wider variety of compositions and properties than suitable aluminum foams. Thus, selection of a suitable brazing flux material and/or filler material may be based more on the particular aluminum foam than on the aluminum extrusion, as the extrusions may generally be custom ordered such that they have properties appropriately suited to a given flux and filler. A suitable brazing filler material may also be an aluminum-based composition, such as an aluminum and silicon-based composition, numerous of which are readily commercially available. Alternative filler materials may be Zinc-based. In embodiments wherein materials other than aluminum are used, different filler and flux materials may be selected.

Once the assembled components are secured together and appropriate brazing filler and flux materials applied, the entire assembly may be placed in a brazing furnace. In the brazing furnace, the assembly may be heated to a temperature sufficient to connect aluminum foam block 32 to extrusion 34 via the brazing filler. Each of the other housing portions may also be connected together via the brazing filler, as well as connected to the aluminum foam. The selected temperature will typically be sufficient to achieve the described connection(s) via the brazing filler, without melting or significantly melting the aluminum from which the housing portions are made. Proper selection of housing and foam materials, and the use of similar metals or alloys such as aluminum for all of the components will allow all or virtually all of the desired connections, structural or otherwise, to be made during a single brazing process, similar to certain known strategies for manufacturing bar and plate style heat exchangers. The brazing temperature may be greater than about 425° C. in certain embodiments, and may further be in the range of about 570° C. to about 630° C., depending upon the selected brazing filler and the composition of the foam and housing portions.

Furnace brazing of the assembly may be either continuous or batch, and may include an initial drying step at about 200° C. for approximately two minutes. Following drying, the assembly may be treated via a heating step wherein the temperature is increased to a maximum (about 570° C. to about 630° C.) within about ten minutes. Once the maximum temperature is reached, the assembly may be subjected to a brazing stage wherein the brazing furnace temperature is held at the maximum for approximately three minutes, then cooled down to room temperature in about thirty minutes, for example. Furnace brazing may take place in an oxygen deficient environment to prevent oxygen contamination. Still other suitable alternative brazing techniques are known to those skilled in the art, and the exemplary process and temperatures described herein should not be understood to limit the scope of the present disclosure. Those skilled in the art will readily recognize that the temperature and duration of each brazing stage will depend at least in part upon the properties of the materials selected for the heat exchanger housing portions and foam, as well as the properties of the brazing materials themselves. For instance, copper foams will typically be brazed at higher temperatures than aluminum foams.

In still further embodiments, alternative joining techniques such as via a thermally conductive epoxy might be used, for example, Aremco-bond 525 which is available from Aremco, of Valley Cottage, N.Y. In such an embodiment, the epoxy may be applied as a thin, uniform layer over the surfaces of heat exchanger 30 to be joined, then cured via heating for two hours at 150° C., for example. A thermally conductive expoxy or other thermally conductive adhesive may be particularly well suited to the step of joining aluminum foam block 32 with extrusions 34.

### Industrial Applicability

In the embodiment of FIG. 1, oil at a relatively high temperature may be cooled by engine coolant fluid at a relatively low temperature via heat exchanger 30. The engine coolant fluid will in turn be heated, and thenceforth returned to radiator 18 where heat may be dissipated to ambient in a conventional manner. Heat exchanger 30 will provide a relatively lighter engine oil cooler than certain earlier designs, without sacrificing performance. In some instances, the aluminum foam used in heat exchanger 30 will exceed the performance characteristics of earlier designs.

Engine coolant will provide one practical heat transfer medium to cool oil such as engine oil in heat exchanger 30, however, water or another suitable fluid might be used without departing from the intended scope of the present disclosure. Further, while it is contemplated that one application for heat exchanger 30 will be as an engine oil cooler, as shown and described herein, the present disclosure is not thereby limited. For instance, heat exchanger 30 might be used to cool transmission fluid or another engine fluid, or it might be used apart from an internal combustion engine altogether, for example, as a heat exchanger to cool or heat certain fluids used in industrial processes and related machinery.

Aluminum has been demonstrated to be a highly efficacious, lightweight and economical heat exchanger material, particularly as used in conventional bar and plate and tube and shell heat exchangers. Despite the advantages offered by aluminum, copper and stainless steel have heretofore been the industry standard, at least in part due to the relative ease with which certain types of heat exchangers using copper and steel may be manufactured by conventional techniques. With regard to nontraditional materials such as aluminum foams, practicable designs and manufacturing strategies for at least certain types of heat exchangers have thus far been elusive. The present disclosure thus provides a manufacturing method and modular heat exchanger design whereby at least some, and in certain embodiments all, components of a metallic foam based heat exchanger may be constructed from aluminum, although the techniques described herein may be applied to traditional heat exchanger materials as well.

The use of the described furnace brazing process further facilitates large scale, relatively rapid production, wherein all or virtually all of the fluid seals and structural connections of the heat exchanger may be forming during a single brazing process. In terms of materials, as well as the manufacturing process itself, the presently disclosed strategy offers significant advantages over earlier designs such as Toonen et al. discussed above, wherein welding or soldering techniques are used to attach various heat exchanger components. While welding and soldering are appropriate in some instances, it is well known to those skilled in the art that aluminum tends to be less well suited to such techniques than other materials.

In many instances, it has been found that conventional welding of aluminum is virtually impossible. Where soldering is concerned, conventional soldering of internal connections may require that the technique used to later attach other components be selected so as not to disturb internal soldered joints. In other words, a high temperature brazing or welding process for structural housing connections may have a tendency to compromise preexisting soldered connections, as the melting temperature for solder tends to be significantly lower than temperatures commonly used in welding and brazing. The same technique may be used for all of the component connections in the present disclosure, and it thus does not suffer from such shortcomings. The overall structural integrity of heat exchangers according to the present disclosure is also enhanced over certain conventional designs, in that a relatively stiff and strong extrusion may be used as a substrate for attaching and supporting the other components. Further still, the described use of a metallic foam block and a planar-faced extrusion represents a design well-suited to compression fitting the foam block within the housing. Other, more complicated, foam and housing configurations can be deformed unsuitably by the forces necessary for compression or crushing of the metallic foam. Finally, brazing tends to provide connections between the various components that are stronger than certain welded or soldered connections.

The present description is for illustrative purposes only, and should not be construed to narrow the breadth of the present disclosure in any manner. Thus, those skilled in the art will appreciate that various modification might be made to the presently disclosed embodiments without departing from the intended spirit and scope of the present disclosure. For instance, while the present disclosure is discussed primarily in the context of an aluminum extrusion serving as the second housing portion for engine coolant fluid, alternatives are possible. A copper extrusion might be used, for example. Similarly, the first housing portion need not be made from aluminum plates, or even made from aluminum. While the present description discusses brazing materials and techniques as being well-suited to manufacturing heat exchangers according to the present disclosure, it is emphasized that some or all of the connections between the components may be made by other means, such as via thermally conductive epoxies or other adhesives, and other known joining techniques. Other aspects, features and advantages will be apparent upon an examination of the attached drawings and appended claims.

What is claimed is:

1. A heat exchanger comprising:
a housing including a first fluid passage and an extrusion having at least one other fluid passage therein; and
a metallic foam configured to exchange heat between fluids in the first and at least one other fluid passage of the housing, said metallic foam being disposed within said first fluid passage and connected with said extrusion via a thermally conducting attachment material.

2. The heat exchanger of claim 1 wherein said metallic foam comprises a metallic foam block, and said extrusion comprises a metallic extrusion having a plurality of fluid passages separated one from the other by a plurality of stiffeners.

3. The heat exchanger of claim 2 wherein said housing comprises a plurality of housing panels positioned about said metallic foam block, said housing panels defining in part said first fluid passage, wherein said metallic foam and said panels are connected with said extrusion via a thermally conducting brazing filler.

4. The heat exchanger of claim 3 wherein:
said extrusion comprises a rectangular aluminum extrusion having peripheral edges and planar front and back surfaces, said stiffeners comprising longitudinal ribs oriented perpendicular said front and back surfaces;
said housing panels comprise aluminum plates oriented perpendicular said front and back surfaces and connected with said extrusion adjacent said peripheral edges via an aluminum based brazing filler; and
said metallic foam block comprises an aluminum foam block compression fit within said first fluid passage, said metallic foam block being connected with one of said front and back surfaces of said extrusion.

5. The heat exchanger of claim 4 further comprising a plurality of heat exchanger subassemblies positioned in a stacked configuration, each said subassembly including at least one aluminum foam block and at least one aluminum extrusion, each said aluminum foam block being compression fit between extrusions of adjacent subassemblies.

6. A method of manufacturing a metallic foam based heat exchanger comprising the steps of:
positioning a plurality of housing panels about a metallic foam, the housing panels comprising a first housing portion;
thermally coupling the metallic foam with a second housing portion that includes an extrusion having therein at least one fluid passage, at least in part via a thermally conducting attachment material; and
joining the first housing portion with the second housing portion at least in part via a step of heating the first and second housing portions together in a brazing furnace.

7. The method of claim 6 wherein the step of thermally coupling the metallic foam with the second housing portion includes attaching an aluminum foam to an aluminum extrusion with a brazing filler, and wherein the coupling step takes place during the joining step.

8. The method of claim 7 wherein the joining step further comprises joining the plurality of housing panels of the first housing portion to the extrusion with the brazing filler, wherein joining the housing panels with the extrusion defines a fluid passage separate from the at least one fluid passage of the extrusion.

9. The method of claim 8 wherein the aluminum foam comprises an aluminum foam block having tapered edges along two opposite sides thereof, the method further comprising the step of cutting the aluminum foam block from a relatively larger block prior to positioning the housing panels thereabout.

10. The method of claim 9 further comprising the step of compression fitting the aluminum foam block within the heat exchanger.

11. The method of claim 10 further comprising the steps of:
positioning a plurality of heat exchanger subassemblies in a stacked arrangement, each of the subassemblies including a first housing portion having at least one aluminum foam block therein and a second housing portion including an aluminum extrusion; and
joining each of the subassemblies of the stacked arrangement at least in part via a step of heating the subassemblies together in a brazing furnace.

12. The method of claim 11 wherein the heating step comprises heating the plurality of subassemblies together in a stage having a temperature in the range of about 570° C. to about 630° C.

13. The method of claim 9 further comprising the steps of:
positioning each one of the plurality of housing panels adjacent a separate peripheral edge of the extrusion;
contacting the aluminum foam block with an outer planar surface of the extrusion; and
applying a brazing filler and a brazing flux material to at least one of the aluminum foam block and the extrusion, prior to the thermally coupling step.

14. The method of claim 13 wherein the applying step comprises applying an aluminum based brazing filler and an aluminum based brazing flux material.

15. The method of claim 9 further comprising the step of extruding the extrusion, including forming a plurality of stiffeners disposed between a plurality of fluid passages within the extrusion.

16. The method of claim 15 further comprising the step of stiffening the heat exchanger via the plurality of stiffeners of the extrusion.

17. A method of cooling oil in an internal combustion engine system comprising the steps of:
passing high temperature oil through an aluminum foam disposed within a first fluid passage in a first housing portion of a heat exchanger;
passing low temperature fluid through at least one other fluid passage in a second housing portion of the heat exchanger; and
exchanging heat between the high temperature oil and the low temperature fluid at least in part via a thermally conducting material joining the aluminum foam with the second housing portion.

18. The method of claim 17 wherein the second housing portion comprises an extruded housing portion having a plurality of fluid passages therein, and the step of exchanging heat comprises exchanging heat between the high temperature oil and the low temperature fluid via a thermally conducting brazing material connecting the aluminum foam to an exterior surface of the second housing portion.

19. The method of claim 18 wherein:
the step of passing high temperature oil through an aluminum foam comprises passing high temperature engine oil through an aluminum foam block about which a plurality of aluminum housing panels of the first housing portion are positioned, the housing panels defining the first fluid passage; and
the step of passing low temperature fluid through at least one passage of the second housing portion comprises passing low temperature fluid through a plurality of fluid passages separated one from the other by a plurality of stiffeners, the second housing portion being an aluminum extrusion.

20. The method of claim 19 further comprising:
passing high temperature oil through a plurality of aluminum foam blocks disposed one within each of a plurality of heat exchanger subassemblies arranged in a stacked configuration; and
passing low temperature fluid through a plurality of aluminum extrusions each connected with at least one of the aluminum foam blocks and disposed one within each of the plurality of housing subassemblies.

21. The method of claim 20 wherein the step of passing low temperature fluid through the plurality of aluminum extrusions comprises passing low temperature fluid through a plurality of fluid passages in each one of the aluminum extrusions, the plurality of fluid passages each being fluidly separated from adjacent fluid passages by stiffeners internal to the respective extrusion and extending longitudinally between an inlet and an outlet of the fluid passage.
